(19) United States
(12) Patent Application Publication
(10) Pub. No.: US 2013/0024344 A1
(43) Pub. Date: Jan. 24, 2013

(54) BIFURCATED COMMODITY IDENTIFIERS

(71) Applicants: David Boberski, Westport, CT (US); John Wiley, New York, NY (US); John Nyhoff, Darien, IL (US); John Labuszewski, Westmont, IL (US)

(72) Inventors: David Boberski, Westport, CT (US); John Wiley, New York, NY (US); John Nyhoff, Darien, IL (US); John Labuszewski, Westmont, IL (US)

(73) Assignee: CHICAGO MERCANTILE EXCHANGE, INC., Chicago, IL (US)

(21) Appl. No.: 13/186,235

(22) Filed: Jul. 19, 2011

(51) Int. Cl. G06Q 40/00

(52) U.S. Cl. 705/37

(57) ABSTRACT

Novel systems and methods for selectively listing a commodity under one or more different commodity codes are provided. A single commodity may be selectively listed under different commodity codes based upon whether it is offered on an opening or closing basis. The commodity may be an Interest Rate Swap (IRS). It may be matched with bids according to a fixed rate variable when listed under the first code. The same commodity may then be listed on the same exchange under a second commodity code. In one embodiment, the commodity listed under the second commodity code may be matched with bids according to a different variable, such as, for example, a currency amount. In one implementation, the currency amount of the second variable may represent a non-par payment.

### BACKGROUND

Modern electronic trading systems tend to offer a very standardized fungible commodity in which one instrument is precisely like another instrument. Standardized quotation conventions permit an efficient liquid market in a multi-lateral environment. For example, once transacted, the positions are submitted or “novated” to an exchange system. As such, the exchange essentially becomes buyer to every seller; and seller to every buyer—in the process assuring the prompt fulfillment of the financial obligations. Because these positions are novated to the exchange, standard quotation conventions do not have a distinction between whether a transaction establishes a new position (an “opening trade”) or whether the transaction serves to offset or close out a previously existing position (a “closing trade”). In fact, multi-lateral trading systems generally do not distinguish between opening and closing trades at all.

Many modern commodities, however, are still transacted on a bi-lateral basis. For example, Interest Rate Swaps (“IRS”) instruments are often traded on a bi-lateral basis. Increasingly, exchanges have been trying to offer IRS and other instruments traded on a bi-lateral basis. Trading certain commodities, however, has proven to be incompatible with multi-lateral execution as currently configured. Attempts to do so have been limited by, inter alia, the lack of distinction between opening and closing positions. Thus, these approaches remove the bi-lateral nature of these transactions among other shortcomings.

Therefore, there is a need in the art for new and improved systems and methods for offering and executing trades for additional commodities.

### SUMMARY

Aspects of this disclosure relate to novel exchange systems and methods configured to selectively list a commodity under one or more different commodity codes. In one embodiment, a single commodity may be selectively listed under different commodity codes based upon whether the commodity is offered on an opening or closing basis. In one embodiment, the commodity may be an Interest Rate Swap (IRS). An exemplary exchange system may be configured to list a commodity under a first commodity code if that commodity is offered on an opening basis. Further embodiments may list the same commodity under at least a second commodity code if that commodity is offered on the closing basis.

In one implementation, a commodity associated with the first commodity code may be matched with a bid based upon a fixed rate. In another implementation, however, the same commodity may be matched with a second bid based upon a currency amount representing a non-par payment value if the commodity is associated with a second commodity code. Various embodiments may implement a matching engine of an exchange computer system to perform at least a portion of the matching of commodities and bids.

In one embodiment, the matching of an IRS commodity offered on an opening basis may include calculating a par value of a fixed rate by determining an equivalent to a present value of fixed rate payments associated with the commodity for a first time frame. The time frame may be the full duration of the IRS commodity. In certain embodiments, a par value of a floating rate associated with the first bid may be determined, such as by determining an equivalent to a present value of floating rate payments associated with the first commodity for the same first time frame. In one embodiment, matching may occur if the difference between the par value of the fixed rate and the par value of the floating rate is within a matching threshold. In one embodiment, the matching threshold may be a par swap.

In accordance with one embodiment, a commodity may be initially listed under a first commodity code and listed under a second commodity code for a second time period. In one embodiment, the commodity may only be associated with the second commodity code after first being matched while listed under the first commodity code. In another embodiment, the commodity may be simultaneously listed under the first commodity code in a first listing and under a second commodity code in a second listing.

Further aspects relate to novel methods of selectively listing commodities under different commodity codes. In one embodiment, a commodity listed under a first commodity code may be associated with a value of a first variable. The value may be configured to be utilized by a match engine of an exchange for matching that first commodity with a bid. For example, the commodity may be an Interest Rate Swap (IRS) commodity and the variable may be a fixed rate. Following matching the commodity with a bid, certain embodiments may implement one or more methods to list the same commodity on the same exchange under a second commodity code. In one embodiment, the commodity listed under the second commodity code may be associated with a value of a second variable configured to be utilized by a match engine of the exchange for matching the commodity with a bid. In one embodiment, the value of the second variable may represent a currency amount. In one implementation, the currency amount of the second variable may represent a non-par payment.

Further aspects relate to novel systems and methods of matching the commodity listed under a first commodity code with a bid. In one embodiment in which the commodity may be an IRS commodity, a par value of the fixed rate may be calculated by determining an equivalent to a present value of fixed rate payments associated with the commodity for a first time frame. In one embodiment, the first time frame may be the full duration of the IRS. Further embodiments may calculate the par value of a floating rate associated with a bid. In one embodiment, this may comprise determining an equivalent to a present value of floating rate payments associated with the same instrument for the same first time frame. In certain embodiments, if the difference between the par value of the fixed rate and the par value of the floating rate is within a matching threshold, then a bid may be matched with the instrument listed under the first commodity code. In one implementation, the matching threshold may be a par swap.

In various embodiments, the present invention can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures. In this regard, other embodiments are disclosed and claimed herein as well.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention; and

FIG. 2 illustrates an exemplary method of listing a commodity under a first commodity code and a second commodity code in accordance with an embodiment of the invention.

### DETAILED DESCRIPTION

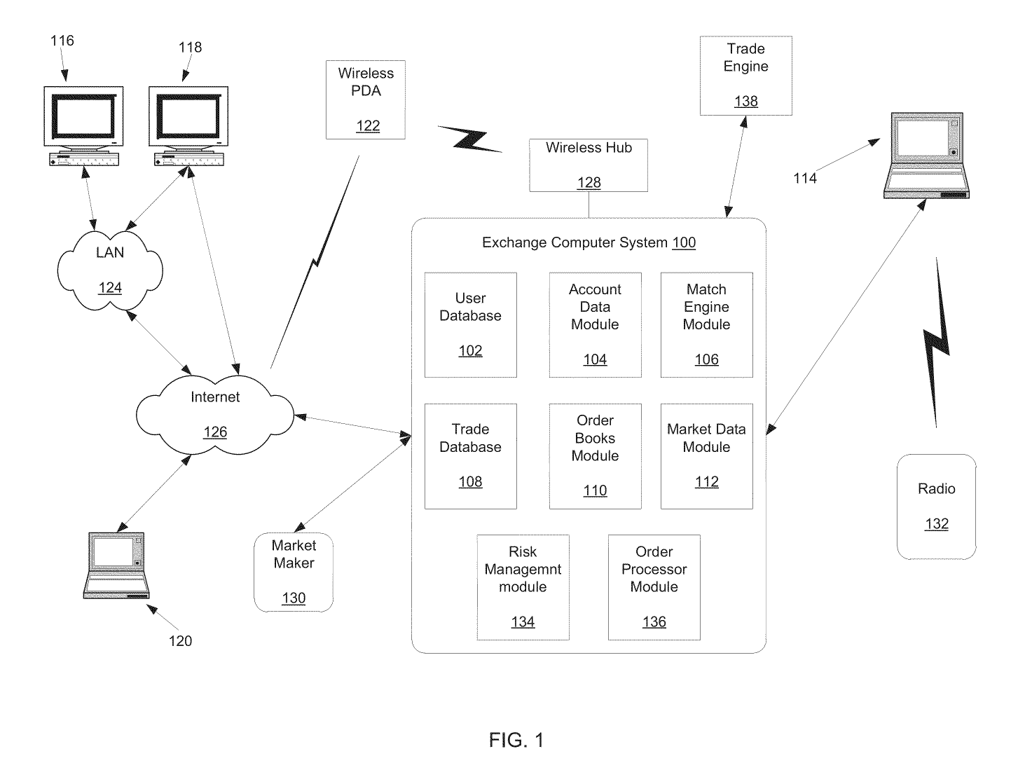

Aspects may be implemented with computer devices and computer networks that may be configured to list a commodity under a first commodity code for a first listing and at least a second commodity code for a second listing. An exemplary trading network environment for implementing trading systems and methods is shown in FIG. 1. In accordance with various embodiments, an exchange computer system 100 receives orders and transmits market data related to orders and trades to users.

In certain embodiments, exchange computer system 100 may comprise a multi-lateral trading system characterized by an open auction-like market that facilitates the anonymous participation of many traders. For example, once transacted, the positions are submitted or “novated” to exchange computer system 100 for purposes of bookkeeping and the application of financial sureties or guarantees regarding the financial integrity of the offers, bids, and matching of the offers and bids. As such, in accordance with certain embodiments, exchange computer system 100 may essentially become buyer to every seller; and, seller to every buyer—in the process assuring the prompt fulfillment of the financial obligations of both buyers and sellers of various commodities.

Exchange computer system 100 may be implemented with one or more mainframe, desktop or other computers. A user database 102 may be included that comprises information identifying traders and other users of exchange computer system 100. Data may include user names and passwords potentially with other information to identify users uniquely or collectively. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processor module 136 may be included to decompose product and aggregate order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or any other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are shown as being coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing bid and offer prices for a commodity such as, for example, an interest rate swap to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems. Coupling can be direct as described or any other method described herein or known.

The operations of computer devices and systems shown in FIG. 1 may be controlled by computer-executable instructions stored on one or more tangible computer-readable mediums. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies. Any module of exchange computer system 100 may comprise a tangible computer-readable medium (a tangible memory module) and a processor. In certain embodiments, one or more modules may share a common processor or computer-readable medium.

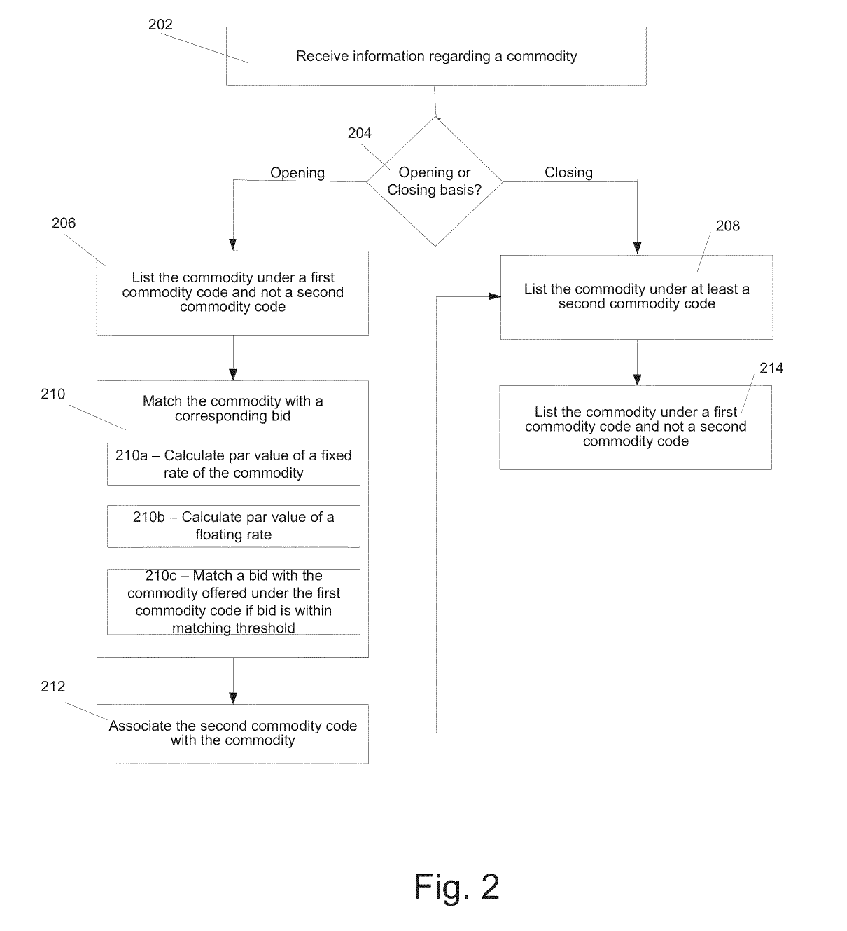

FIG. 2 is a flowchart of an illustrative method that may be used to create multiple liquidity pools for a single commodity in accordance with one embodiment of the invention. In one embodiment, a commodity may be selectively associated with two or more commodity codes. Looking to the exemplary method of FIG. 2, electronic information regarding a commodity may be received (i.e., block 202). For example, the information may be transmitted through one or more communication pathways and received at exchange system 100 of FIG. 1, such as for example, a communication module of system 100 operatively connected to internet 126, wireless hub 128, trade engine 138, radio 132, among others.

The identified commodity may be any product, good or service that is transferrable. In certain embodiments, the identified commodity may be a commodity that has traditionally been traded or negotiated on a bi-lateral basis (i.e., privately negotiated) between two specific counterparties, and not through exchange systems, such as for example, exchange computer system 100. In one embodiment, the commodity identified in block 202 may be an Interest rate swap (“IRS” or “swap”).

Using an IRS as an illustrative example, it is a financial transaction that entails multiple, periodic payments (“swaps”) of a sum determined by reference to a fixed or invariable rate of interest and payable by the swap “buyer”, and then a sum determined by reference to a floating or variable rate of interest and payable by the swap “seller.” For example, a seller may desire to swap a quarterly payment based upon a specified fixed rate of interest, such as 1% applied to a principle value of a monetary currency, such as $50 million U.S. Dollars for a 5 year duration in exchange, for example, a quarterly payment (or any other interval) based upon a floating interest rate, such as for example, a 3-month LIBOR rates applied to a principle value of the same value of monetary currency ($50 million U.S. Dollars). In this example, the seller (the fixed rate payer) desires that the quoted floating rate rise such that his receipts are increased. In contrast, the buyer (the floating rate payer) hopes that floating rates decline such that his payments are diminished. Those skilled in the art will appreciate that the LIBOR rate is merely an example of one from a plurality of potential sources that may be utilized for the determination of a floating rate. Another example may be a Treasury bill rate. The determination or calculation of rates (including fixed or floating rates disclosed herein) may be received from a plurality of disparate sources. In certain embodiments, information relating to the fixed or floating rates may be received from market maker 130 or trade engine 138 of exchange computer system 100.

Further information (which may be received at block 202) may comprise an indication of whether the first commodity is being offered on an opening basis or a closed basis. As used herein, “opening basis” offerings are inclusive of transactions that establish a new position. In contrast, “closed basis” transactions include offerings that would offset or close out a previously existing position (i.e., a “closing trade”). The identification of the first commodity as either being on an opening basis or a closing basis may be based upon a user input. The user input may be remotely received, such as through a user on computer 116.

In this regard, certain embodiments may require a user attempting to trade the commodity on exchange system 100 to indicate whether the commodity is on an opening or closing basis. This information may be received at exchange system 100 through communication pathways discussed above or known in the art.

The electronic information may identify one or more features of the commodity including, for example, the duration or time frame for a full term of commodity, intervals of periodic payments, and a value of a first variable. For example, if the first commodity is an IRS commodity and the value of the first rate may be a fixed rate. As explained later in this disclosure, including at least in relation to block 208, the commodity may be matched to a bid based upon a value of the first variable. Although a fixed rate is described as a potential first variable, those skilled in the art with the benefit of this disclosure will readily appreciate that other features may be utilized as a variable for the commodity.

Certain embodiments may require the reception of certain types and/or quantities of information before the commodity is permitted to be listed on an exchange, such as exchange computer system 100. The type and quantity of information required may depend on one or more factors, including but not limited to: the type of commodity, governmental rules and regulations, specific requirements of the exchange system, and a combination thereof. In one embodiment, a commodity may be an IRS commodity and information regarding a time frame for the full term of the commodity is required to be received. Periodicity of payments may also be required. In certain embodiments, a first type of information may be required if the commodity is identified as being offered on an “opening basis” and a second type of information may be required if that same commodity is identified as being on a “closing basis.”

Block 204 may be implemented by computer exchange system 100 to determine if the commodity of block 202 is identified as being offered on an opening basis or a closed basis. In one embodiment, this determination may be made by order books module 110. Yet any other module within system 100 may be utilized at block 204, either alone or in combination with order books module 110 and/or other portions that collectively comprise at least one tangible computer-readable medium and a processor. The determination may be made based on information directly received from a potential seller (i.e., a fixed rate payer in an IRS swap). In other embodiments, the determination at block 204 may be derived from information from one or more different sources, including information collected from market data module 112, market maker 130 and/or trade engine 138, among others.

If at block 204 it is determined the commodity is offered on an opening basis, block 206 may be implemented to list the first commodity on exchange system 100 under a first commodity code, whereas if the commodity is offered on a closing basis, block 208 may be implemented to list that commodity on the exchange system 100 under at least a second commodity code. In this regard, novel aspects of this disclosure relate to methods for listing a single commodity under two or more different commodity codes.

Looking first to block 206, a first commodity code may be assigned to the commodity and listed on the exchange computer system 100. In one embodiment, the second commodity code discussed above in relation to block 208 cannot be associated with the first commodity at this point in time because the commodity is being offered on an opening basis. Therefore, in certain embodiments, a determination of whether this commodity is offered at an opening basis or a closing basis (which may be determined from the information received at block 202) may determine a commodity code to be assigned to the first commodity. For example, an IRS commodity provided on an opening basis may be assigned a first code. If, however, it is indicated to be offered on a closing basis, a second commodity code may be associated with the IRS commodity (see, e.g., block 208).

Using different commodity codes for the same commodity (i.e., an IRS commodity) essentially permits two markets, or liquidity pools, with respect to that commodity with its particular terms and conditions, i.e., term, reset dates, date conventions, reference rates, etc. In this regard, the commodity code(s) for which the first commodity is listed under determines how that commodity is quoted and compared against potential bids (for example by a matching engine, such as matching engine module 106). For example, if a specific commodity is listed under a first commodity code, it may be quoted in accordance with a fixed rate, whereas if the same IRS commodity is provided on a closing basis, it may be quoted under a second commodity code, such as in the form of monetary currency. The fixed rate and/or monetary currency values may be received from a user, such as through block 202 as well as derived from other sources as discussed above, including from market data module 112, market maker 130 and/or trade engine 138.

At block 210, the commodity listing may be matched (such as by utilizing match engine module 112) with a corresponding bid. Commodities listed under the first commodity code (which may be the opening basis commodities) may be matched on the basis of the fixed rate (i.e., be yield based). In certain embodiments, order books module 110 may assist in matching offers and bids, for example, by computing or determining current bid and offer prices/rates. Those skilled in the art will appreciate that there are many well-known techniques for matching offers and bids and that the aspects of the invention disclosed herein are not dependent on the specific mechanisms for matching.

One exemplary method for matching may match an IRS instrument as having a first fixed rate to a bid of a floating rate, when the floating rate equals the fixed rate. For example, block 206 may be implemented to list an IRS on an opening basis. Thus, block 210 (or any other process) may comprise one or more processes for calculating a fixed rate. For example, the fixed rate may be calculated as the rate that renders equivalent the present value of the anticipated periodic fixed rate payments (PV_{fixed}). In one embodiment, sub-block 210a may be implemented to calculate the par value of the fixed rate of the commodity (an IRS instrument) by determining an equivalent to a present value of fixed rate payments associated with that commodity for a time frame (such as, e.g., the duration of the instrument).

Sub-block 210a may be followed by a determination of the present value of the anticipated periodic floating rate payments (PV_{floating}) during the same time frame (see, e.g., sub-block 210b). Thus, in certain implementations of block 210, sub-block 210b may be implemented to calculate the par value of a floating rate associated with a bid by determining an equivalent to a present value of floating rate payments associated with the same instrument for the same first time frame. In one embodiment, the floating rate payments may be estimated by reference to the shape of the yield curve in certain embodiments.

At sub-block 210c, match engine module 106 may match a bid with the commodity offered under the first commodity code, if the difference between par value of the fixed rate payments (PPV_{fixed}) and the par value of the floating rate payments (PPV_{floating}) of a bid is within a matching threshold. The matching threshold may be a par swap in which PPV_{fixed}=PPV_{floating}. Information regarding an executed trade may be stored on a tangible computer-readable medium, such as located at trade database 108 of computer exchange system 100.

Further aspects of this disclosure relate to listing a commodity on an exchange system, such as exchange computer system 100, under a first commodity code during a first time period and as a second commodity code on the same exchange system during a second time period that is after the first time period. For example, upon matching a commodity on an opening basis (e.g., at block 210) under the first commodity code, block 212 may be implemented to associate the second commodity code with that commodity. In one embodiment, the same commodity may be listed on the same exchange under a second commodity code after it is matched with a bid. In one embodiment, exchange system 100 may alter the commodity code to the code associated with closing transactions of that commodity and assign relevant information to the transaction with the second commodity code (which may be a “closing basis” commodity code). In yet other embodiments, the first commodity may be associated with the first and the second commodity codes. In one embodiment, the first commodity code retains association with the commodity for a fixed time frame after matching. For example, in one embodiment, a matched commodity may retain association for a time period that is fixed to its position. If the commodity remains in the same position, it will retain association with the first code despite the fact that it has been matched, and perhaps listed under a second commodity code as well. In other embodiments, the first commodity code may be associated until appropriate records, such as accounting records, can be updated. In one embodiment, the first commodity code may remain associated with the commodity to a fixed time, such as a close of a market. In yet other embodiments, the first commodity code may remain associated with the commodity even after its position has changed and it is listed under the second commodity code.

The commodity listed under the second commodity code (such as at block 208) may comprise a value of a second variable configured to be utilized by a match engine (i.e., match engine module 106) of the exchange for matching the commodity with a bid. For example, the value of a second value may be a currency or monetary value. In one embodiment, the currency amount of the second variable may represent a non-par payment. Exemplary Listings #1 and #2 are provided below as exemplary listings that may be listed for matching on an exchange in accordance with certain embodiments disclosed herein.

Specifically, Listing #1 provides an exemplary format of a potential listing for a commodity on the exchange system under a first commodity code and Listing #2 provides an exemplary format of an illustrative listing for the same commodity under a second commodity code on the same exchange system.
Listing #1: [Opening Commodity Code] [value of first variable] [periodicity of payments] [duration]
Listing #2: [Opening Commodity Code] [value of first variable] [periodicity of payments] [duration] [Closing Commodity Code] [value of second variable]

Thus, using Listing #1 as an example for an IRS instrument offered on an opening basis in which first variable is a fixed rate of 3%, having payments due every six months for 5 years (or 60 months) may resemble:

OIRS, 3.0, 6, 60

Similarly, using Listing #2 as an example for the same IRS instrument after it has been matched (for example, at block 210) and subsequently associated with a second commodity code (for example, at block 212) may resemble:

OIRS, 3.0, 6, 60, CIRS, 500

Thus, in certain embodiments, the commodity may be listed on the exchange under the first commodity code and the second commodity code. In certain embodiments, however, the first commodity code may be disassociated from the commodity upon the association of the second commodity code. Thus, in certain embodiments, only a single commodity code may be associated with the commodity at any given time. In further embodiments, the commodity can only be associated with the value of the first value and not the value of the second variable during a first time frame. For example, while the commodity is associated with the first commodity code, it may be matched to bids on the basis of the fixed rate, however, cannot be matched with bids on the basis of a currency amount.

In this regard, after the second commodity code has been associated with the commodity, the commodity may be matched with a bid (see, e.g., block 214). The matching may be done by match engine module 106 in which the commodity is matched against bids according to the value of the second variable. In certain embodiments, the second variable may be the only variable utilized by the matching engine module 106 when matching commodity under the second commodity code. In embodiments in which the commodity is an IRS, the second variable may relate to a currency amount. In one embodiment, the currency amount may represent a non-par payment.

Although exemplary embodiments have been described in which the commodity was first listed on exchange system 100 under a first commodity code (i.e., block 206) and then, after being matched, listed under a second commodity code (i.e., going from block 212 to block 208), those skilled in the art will readily appreciate that a commodity may be simultaneously listed under a first listing using a first commodity code and a second listing using a second commodity code. In further embodiments, the commodity may only be listed under the second commodity code.

Of course, one or more of the blocks shown in FIG. 2 may be implemented in an order different than shown. Further, certain blocks may be omitted. For example, there is no requirement that block 206 be implemented before an implementation of block 208.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. All are considered within the sphere, spirit, and scope of the invention.

We claim:

1. A computer-implemented method comprising:
listing on an exchange, a first commodity associated with a value of a first variable configured to be utilized by a match engine of an exchange for matching the first commodity with a bid, wherein the first commodity is listed on the exchange under a first commodity code;
matching with a match engine, the first commodity under the first commodity code with a bid; and
after the first commodity is matched with a bid, listing the same first commodity on the same exchange under a second commodity code.

2. The method of claim 1, wherein the first commodity listed under the second commodity code comprises a value of a second variable configured to be utilized by a match engine of the exchange for matching the first commodity with a bid.

3. The method of claim 1, wherein the value of the first variable represents a fixed rate.

4. The method of claim 2, wherein the value of the first variable represents a fixed rate and the value of the second variable represents a currency amount.

5. The method of claim 4, wherein the first commodity is an interest rate swap instrument and the matching of the instrument listed under the first commodity code is matched with a bid according to the method comprising:
calculating the par value of the fixed rate by determining an equivalent to a present value of fixed rate payments associated with the instrument for a first time frame;
calculating the par value of a floating rate associated with a bid by determining an equivalent to a present value of floating rate payments associated with the same instrument for the same first time frame; and
if the difference between the par value of the fixed rate and the par value of the floating rate is within a matching threshold, then matching the bid with the instrument listed under the first commodity code.

6. The method of claim 5, wherein the matching threshold is a par swap.

7. The method of claim 6, wherein the currency amount of the second variable represents a non-par payment.

8. The method of claim 1, further comprising:
receiving electronic information comprising a request from a first user to list the first commodity on the exchange on an opening basis.

9. The method of claim 2, further comprising:
after associating the first commodity with the second commodity code, listing the first commodity on the exchange under the first commodity code and the second commodity code.

10. The method of claim 2, wherein the second commodity code is assigned to the first commodity based on a fixed time.

11. An exchange system comprising:
a module configured to receive electronic information comprising:
an identification of a first interest rate swap commodity including
a time frame for a full term of the first commodity; and
an indication of whether the first commodity is being offered on an opening basis or a closed basis;
a processor and a non-transitory computer-readable medium comprising computer-executable instructions that when executed by the processor perform the method comprising:
listing the first commodity on the exchange system based upon the identification whether it is on the opening basis or the closing basis;
wherein, if it is offered on the opening basis, listing the first commodity on the exchange system under a first commodity code and, if it is offered on the closing basis, listing the first commodity on the exchange system under at least the second commodity code; and
a match engine configured to match the first commodity with a bid;
wherein if the first commodity is associated with the first commodity code and not the second commodity code, the matching engine is configured to permit matching the first commodity with a first bid based upon a fixed rate; and
wherein if the first commodity is associated with the second commodity code, the match engine is configured to permit matching the first commodity with a second bid based upon a comparison of a currency amount representing a non-par payment value.

12. The exchange system of claim 11, wherein the matching of the first commodity with the first bid comprises:
calculating a par value of the fixed rate by determining an equivalent to a present value of fixed rate payments associated with the instrument for a first time frame;
calculating a par value of a floating rate associated with the first bid by determining an equivalent to a present value of floating rate payments associated with the first commodity for the same first time frame; and
if the difference between the par value of the fixed rate and the par value of the floating rate is within a matching threshold, then matching the bid with the instrument listed under the first commodity code.

13. The exchange system of claim 12, wherein the matching threshold is a par swap.

14. The exchange system of claim 11, the computer-readable medium further comprising computer-executable instructions that when executed by the processer perform the method comprising:
after associating the first commodity with the second commodity code, listing the first commodity on the exchange under the first commodity code and the second commodity code.

15. The exchange system of claim 14, wherein the first commodity is simultaneously listed under the first commodity code in a first listing and under a second commodity code in a second listing.

16. A non-transitory computer-readable medium comprising computer-executable instructions that when executed by a processor perform the method comprising:
listing on an exchange a first commodity associated with a value of a first variable configured to be utilized by a match engine of an exchange for matching the first commodity with a bid, wherein the first commodity is listed on the exchange under a first commodity code;
matching with a match engine, the first commodity under the first commodity code with a bid; and
after the first commodity is matched with a bid, listing the same first commodity on the same exchange under a second commodity code.

17. The computer-readable medium of claim 16, wherein the first commodity listed under the second commodity code comprises a value of a second variable configured to be utilized by a match engine of the exchange for matching the first commodity with a bid;

18. The computer-readable medium of claim 17, wherein the value of the first variable represents a fixed rate.

19. The computer-readable medium of claim 17, wherein the value of the first variable represents a fixed rate and the value of the second variable represents a currency amount.

20. The method of claim 19, wherein the first commodity is an interest rate swap instrument and the matching of the instrument listed under the first commodity code is matched with a bid according to the method comprising:
calculating the par value of the fixed rate by determining an equivalent to a present value of fixed rate payments associated with the instrument for a first time frame;
calculating the par value of a floating rate associated with a bid by determining an equivalent to a present value of floating rate payments associated with the same instrument for the same first time frame; and
if the difference between the par value of the fixed rate and the par value of the floating rate is within a matching threshold, then matching the bid with the instrument listed under the first commodity code.
